(19) United States
(12) Patent Application Publication
(10) Pub. No.: US 2011/0175724 A1
(43) Pub. Date: Jul. 21, 2011

(54) Event and Time Tracking and Emergency Notification System

(76) Inventor: Angela Petra Kent, Las Vegas, NV (US)

(21) Appl. No.: 12/689,189

(22) Filed: Jan. 18, 2010

(51) Int. Cl. G08B 1/08; G08B 23/00

(52) U.S. Cl. 340/539.13; 340/573.4

(57) ABSTRACT

A system and method for tracking subscribing users and time periods input by users for a specific future event occurrence. Tracking is determined by a computer network based system which allows for users to input details of specific upcoming events including but not limited to, time of departure, location, and estimated time of arrival. If the user does not confirm their arrival with the service provider server during a determined time interval, user input emergency contacts, relative to the individual event being tracked, will be contacted to alert of a possible problem. GPS location via a locating device can also be integrated to give the emergency contacts the exact location of the user.

### FIELD OF INVENTION

The disclosed system and method relate generally to tracking of elapsed time for user determined events. More particularly, it relates to a network based system in which a user is registered and inputs certain details of upcoming events and allows for alerts to be sent out to emergency contacts if the user does not ‘check’ back to the system to confirm arrival/return for the event in the prescribed time period.

### BACKGROUND OF THE INVENTION

In today's busy world it is hard enough to keep track of one's own schedule, let alone another individual's. In cities and suburbs alike, people tend to be out-and-about more and more, whether it be to go to work, run errands, or go on vacation. When an individual goes about these things they usually have best intentions in mind and normally will have a set time period in which they intend to get these things done. But of course the world doesn't work off best intentions and every-so-often throws a wrench into the works and something unexpected can happen. In this situation an individual would contact their loved ones and friends to alert them of the changes, but in cases of extreme danger or peril, the ability to contact these individuals may be hindered or lost altogether. With the introduction of a tracking system, such occurrences could be monitored by outside parties or they can be alerted if assistance is needed, and in the cases of extreme danger, lives can be saved.

Eyeline Communications has a pending U.S. patent application called ‘Arrived Ok’ which teaches a service that tracks pre-programmed air flight events on behalf of a registered user to a website and notifies pre-programmed lists of parties about the arrival to their destination via cell phone tracking. This invention specifically relates to airline travel and therefor is limited in its use. Also, the system relies on cell phone communication and would not be desirable in situations where you may not have a cell phone available such as hiking or camping.

U.S. Pat. No. 6,239,700 to Hoffman teaches a personal security and tracking system where a user can initiate a distress alert to appropriate personnel, whom then can track and locate the individual, via GPS or other locating system. The system requires the user to wear a portable signaling unit as well as a remote alarm switch unit at all times. This system also requires a central dispatch station to which signals are transmitted. This system requires expensive equipment and who's method involves user input for a distress signal and does not allow for automatic alerts if the user is unable to access the distress switch in cases medical emergencies where the user cannot physically access it or if it is lost.

U.S. Pat. No. 6,054,928 to Lemelson and US Pat. No 2007/0159343 to Crucilla teach of devices and methods to monitor and track prisoners, parolees, persons in conditional release programs, and individuals of the like. Both patents teach of a monitoring device that must be worn by an individual to track positional data as well as other relevant information. Both systems incorporate a database where prohibited/permitted locations for an individual as well as permissible time allocation for the permitted locations are stored per individual and alerts the proper authority when disobeyed. Both patents are very strict in their use and do not see any cross over to public use.

Accordingly, there is an unmet need for a web or network implemented system and method, to provide a user with means for personal monitoring and tracking of user chosen individual events and future estimated time frames, and user chosen notifications pursuant to user chosen rules. Such a method should provide an easy manner for a user, and those parties concerned with the whereabouts of the user, to enter and set up future monitoring of future time periods and events. The system should allow for input of sufficient detail to accurately track and notify respective user designated parties, for each event, of the fact the user has exceeded a specific time period related to a specific event. Additionally, such a system should allow both user and outside parties to access the system prior to the elapse of a user set time period, to ascertain on the status of the user relative to the event being tracked. Such a service should also allow designated parties to see exact locations of the user via GPS, cellular triangulation, or other geographic locating methods. Finally, such a system should be enabled to send real time alerts to the user and user-designated outside parties associated with the user input event or time frame, when certain prerequisites of the monitored event being tracked are not met, such as when the user is due back from a specific location visited.

### SUMMARY OF THE INVENTION

The disclosed system and method provide easy and dynamic personal tracking and monitoring system for subscribed users to the system. According to user chosen prerequisites, an alarm may be issued to user designated recipients should the user fail to meet preset finishing times for specified events.

In the web-based system, a service provider uses a server running software adapted to the task of tracking individual user input for subsequent time frames. Once input, the system, for each user and each input event, counts down to a predetermined time which, if passed, will cause an alert to be issued to a user designated recipient.

Once subscribed, users will be prompted to enter information into the system using menu driven screens which receive data in fields which are transmitted to the server software for inclusion into their profile and any tracked future events.

In use, users typically provide information about themselves into the system. Such information includes but is not limited to:

Date of birth, height, weight, drivers license number, cell phone number, email address, hair color, eye color, glasses or contacts, pictures, birthmarks, tattoos, and piercings.

Once personal information is entered, the user then proceeds to input emergency contact information and who or what entity will be notified in the event that a user input event exceeds the user input maximum time. The emergency contact information includes relatives, emergency or medical personnel, or may include additional information the user already provided.

When an event comes up that the user wants to have monitored that event information is then input. Such events include, but are not limited to, errands, hiking, camping, dating, road trips, and elderly care. The event then creates an event profile where specific information is input, including but not limited to:

Location, means of travel (i.e car, bike, walk . . . ), other participants (including their personal information), time of departure, and estimated time of arrival/return. This information is viewable by both user and emergency contacts. The user also inputs a period of leeway around the estimated time of return to ‘login’ to the monitoring system and essentially disarm it. Immediately before departure, the user sets the system (via internet access, SMS, cell phone, toll-free number, or email) to begin monitoring. The user may select to send notices to the list of contacts to alert an event is starting.

If the user accesses their account (via internet access, SMS, cell phone, toll-free number, or email) before the estimated time of return or within the leeway period, if any is defined, then the monitoring period is ended and alerts may be sent out to contacts informing them of a safely completed event if such is defined by the user. Such alerts may be sent to some contacts such as relatives informing them of a completed event, and not sent to others such as emergency personnel since they have no need to know a routine event is ended.

Otherwise, if no stop command is given by the user, for whatever reason, then notices are sent out to contacts to alert of an incomplete event transaction and allows the emergency contact or contacts to proceed with more drastic measures if subsequently ascertained as necessary. GPS tracking devices can also be obtained by the user wherein live location monitoring, subsequent to an alert, can be seen by registered emergency contacts, when deemed necessary.

For example, Jane is a college student and lives with roommates. Jane is on the lookout for a new man in her life and is currently an active dater. There have been cases of sexual misconduct among the fraternity members who make up most of the male population so Jane's roommates have been warning her to be careful. As a compassionate person, Jane sees her roommate's concern as a real warning to possible danger and decides to join the DueBak Elapsed Time Monitoring System website. Jane's roommates are glad that she is taking this initiative and are more then willing to be part of Jane's emergency contact list.

That evening Jane is in the library when she is approached by a young man named John who strikes up a conversation and they hit it off. After a hour of talking, they decide they are going to go have dinner. Jane is excited and wants to let her roommates know her plans but realizes that one is at work and the other is in class and are not available to talk. Jane checks-in to DueBack's system and begins to input the date into an event profile. She also enters a brief description of John (i.e height, build, eye/hair color) into the event profile. Jane usually studies until 6:30 pm and she and John make plans to go to a restaurant that is 15 minutes away. She figures they will eat for about an hour, and will allow for another hour to finish up her evening and get home. She inputs the estimated time of return from the date as 8:45 pm. Jane confirms the inputted data and soon after, Jane's roommates get notified (via text, voice mail, or email) that Jane has left on a date at 6:30 pm with a male named John to a restaurant and is estimated to be home by 8:45 pm. The notice continues to explain how if they do not hear or see from Jane by 9:15 pm that they will be notified of an incomplete event and possible problem and they should be prompted to further contact Jane. It is now 9:16 pm and the roommates have not heard back from Jane as they receive alerts that the monitoring period has expired and that Jane had not attempted to stop the event tracking. Luckily, Jane had also decided to obtain a GPS tracking key chain provided by DueBak services, so the roommates can log on and see that Jane is already outside the house being dropped off by John. Had circumstances been otherwise, the roommates could have located Jane via GPS, as well as given the proper authorities the last known location and description of the person she was with.

With respect to the above description, before explaining at least one preferred embodiment of the web based, user designated time and location tracking system in detail, it is to be understood that the invention is not limited in its application to the details of operation nor the arrangement of the components or steps set forth in the following description or illustrations in the drawings. The various methods of implementation and operation of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other devices and systems for carrying out the several purposes of the disclosed user initiated time and event tracking and notification system herein.

It is important, therefore, that the objects and claims be regarded as including such equivalent construction and methodology insofar as they do not depart from the spirit and scope of the present invention.

Further objectives of this invention will be brought out in the following part of the specification wherein detailed description is for the purpose of fully disclosing the invention without placing limitations thereon.

It is thus an object of this invention to provide a network or web based user initiated tracking system for user designated time frames and events.

It is a principal object of this invention to provide such a network based system which allows a user to input future tracked time periods as they relate to an event and/or location, and issue alerts to user designated parties should a preset time be exceeded.

It is an object of this invention to provide such a tracking system which may be individualized by the user for each event tracked as to time, location, route, and parties to be notified for that event.

It is an additional object of this invention to provide such an improved user designated event and time tracking system that in addition to issuing alerts after the elapsed time, will optionally issue reminders before the future time.

These together with other objects and advantages which become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF DRAWINGS

FIG. 1 is a graphic depiction of a flow chart for system herein showing a new user sign in, registered user login, and a flow path of events and alerts based on a subscriber input future time frame or event.

### DETAILED DESCRIPTION OF PREFERRED EMBODIMENTS

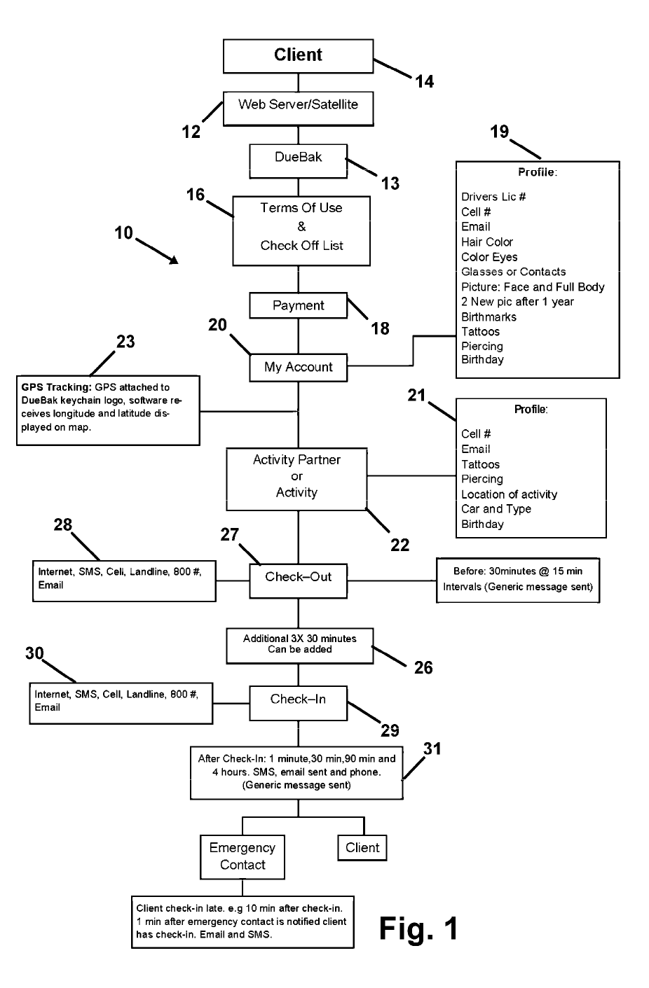

Referring now to the drawing in FIG. 1, some preferred embodiments of the present invention in current preferred modes are shown and described.

The method and system 10 is operated from a network accessed server at the service provider 12. The server would run or be in communication with computers running software adapted to input events, track, and alert designated parties for each tracked event. It is thus highly customizable by the user as to each individual tracked time period as to the destination location, time due back, option to disarm, and notification of specific parties relative to each tracked time period. User location tracking may be enabled by communication of GPS or cellular triangulation information transmitted by a user to the server.

In initial use, the user would log into the server 12 to subscribe, effect payment, and enter their specific user profile of information as to location, appearance, habits, disabilities, and other information relative to the user.

As depicted in FIG. 1, a client or user 14 may acquire the services of the service provider 12 via the internet, or other networked means of communication such as cellular phones and networked television and games.

During the initial subscription steps of sign up the user (14) accesses the system provided by the service provider 12. Presented with terms of use 16, the user accepts or rejects the terms of use 16 of the service provider 12. Once accepted, the user payment information and method 18 is input to pay for the user subscription. Or, in some instances when provided in conjunction with some other service or purchase, the subscription may be free and the user would still be allowed to access the system and employ some or all of its capabilities.

Subsequent to the initial subscription steps, a specific user profile entry 19 relating to the user account 20 is created by the user. This is done in a conventional remote networked fashion employing software running on the server 12 or communicating computers whereafter the client or user 14 is presented with screens to enter personal information.

Such personal information in the profile entry 19 can include, but is not limited to, driver's license number, cell number, home and business phones, email, hair color, eye color, glasses or contacts, pictures, birthmarks, tattoos, piercings, birthday, car license number, home and business addresses, friends, common venues visited, and whatever information is germane to tracking the subscribing user in the future at their bequest.

Also elicited by software running and presenting screens to the subscribing clients or users 14, a contact profile 21 list for input of emergency or contacts chosen by the user and stored on memory accessible by the server 12. This contact profile 21 of emergency contacts may be general, or, may be categorized as to third parties to contact relative to specific occurrences in the future.

Later employment of the contact profile 21, allows the server 12 using software acting for the service provider 13 noted as Duebak, the ability, in the future, to notify a person or agency listed in the contact profile 21 and related to the client or user 14, of an event resulting from a user input of that event or activity input 22 to be monitored.

Different types or levels of such events or activity input 22, may require different third parties to be contacted from the contact profile 19. Consequently the profile 19 when input by the user or client 14 may be provided in a fashion wherein the user or client 14 may designate different third parties to be contacted based on the event which occurs in the future. In a case of emergency or other designated reasons in the future, this input profile 19 information will be used to identify the user 14, and to contact and provide information about the user 14 to one or a plurality of third parties so designated at any differing levels of importance or input.

For instance a late arrival by the client or user 14, may have the server 12 or other persons or electronic means for contact, to communicate to a relative of the client or user 14. However, should the client or user 14 be monitored for location, by the optional GPS tracking 23, and a location determined thereby to be a risk to the user's health or life, the third parties contacted may be police and rescue as well as a relative. Thus, the client or user 14 may designate in the input profile 19, different third parties to be contacted, relative to the degree of the input event 22, and/or the degree of emergency or urgency related thereto in the future.

Once personal information in the profile 19, and emergency information, and third party contact information of the contact profile 19, has been elicited by the provider 13 through an interface on the server 12, or by phone, fax, or other means of allowing the user to input such information, it is entered and electronically stored and employable by the software running on the server 12 of the provider 13 in a relational database. Thereafter the client or user 14 is allowed to communicate with the server 12 of the system provider 13 at any time in the future to initiate a tracking request of an event 22 with an activity partner, traveling to a destination, or engaging in an activity, or other event 22 the client or user 14 wishes tracked.

For such a tracking occurrence, when the user decides they wish to track an upcoming event 22 for a specific time duration, the event information relating to an activity such as a destination or travel with an activity partner, is inputted by the client or user 14 into the server 12 of the service provider 13 and related to their input profile 19. The system being individualized by each client or user 14, is adapted to track specific future individual events 22 by time frame or duration. Thereafter it relates individual input events 22 to the specific location the client or user 14 will visit, their route, their means of travel be it private vehicle or public transportation, their estimated departure time, their estimated return time, and any business or person or activity partner which has been associated with the event 22 during input.

In an event 22 tracking, should the vehicle used be owned by an acquaintance, vehicle identification information may be elicited during input of the event 22 using software adapted to elicit such information from the client or user 14. Further, should an event be a sequential plurality of events 22, in that the user will visit numerous locations in a sequence, information relative to each location would be included in the elicited input of the event 22.

The information for an individual or sequential event 22 input by the client or user 14, would be menu driven and elicited by the software running on the server 12 of the service provider 13. A sequential presentation of screens for entry of the information concerning each event 22 would be presented. The screens provide input windows for the client or user 14 to enter data which may be employed by the software of the server 12 of the provider 13 to store the individual fields of information in a relational database for that user 14 and each input event 22 in the future.

The input information concerning each individual event 22 is saved in electronic memory accessible by the server 12 of the service provider 13. Thereafter, once sufficient event information is input, and the client or user 14 is finished to the point the software adapted to the task can ascertain sufficient information to monitor and report on the event 22, the subscribing client or user 14 may log out of the server 12 or other networked means for input of user events 22. Should the events 22 input be repeatable in that the user frequents the locations often, the events 22 may be saved for future subsequent re-input thereby allowing the client or user 14 to input future such specific events 22 by choosing one from a menu of venues and locales that are saved in repeating events 22 relating to that client or user 14.

In use, once the information about a specific future event 22 has been input, tracking by the server 12 of the service provider 13 or computers running software and communicating with the server 12 is initialed automatically. This tracking of the event 22 is done at a predetermined time, or preferably by a user check-out input 27 communicated to the server 12 noting the user is checking out for their trek to the event 22 previously input to a venue itemized in the previously input event 22. If automatic tracking is requested, a timer will begin a tracking of the event 22.

More preferable for increased accuracy and prevention of false alarms, input of the start of an event 22 may be entered using any means of networked communication which will communicate with the server 12 or other input means of the service provider 13 to initiate the tracking of the event 22. This input means can include any means for a remote electronic communication of the starting an event 22 such as logging back into the server 12, calling an 800 number, email, sms text message via cell phone to a predetermined recipient or computer, or any means to communicate the start of the event 22 to be monitored by the service provider 13 server which will interface with the server 12 or computers tracking the event 22 using software adapted for such, and to initiate a tracking of the event 22 related to the individual client or user 14.

Once tracking is initiated by the client or user 14, for their pre-entered event 22, it will optionally cue the server 12 of the service provider 13 to dispatch a Check-out message 28 (via email, cell, text, electronic call, or any such method) to all designated emergency contacts associated with the event 22 in the input profile 19 of the client or user 14. The communicated message 28 so initiated, may be informing them of the start of an event 22 or whatever information is applicable to the communication. For example the message “Jane has left her apartment at 6:30 pm driving a silver BMW to Aspen, Colo. and is expected to arrive in Aspen at 10:15 pm at the Holiday Inn” in Aspen.

If the user discerns at this point, or any point during the tracking of the previously input time period for the event 22, that more time is needed, then the user may chose to add a ‘buffer’ time 26 to be communicated to the monitoring computers or server 12 of the new estimated time of arrival. If the buffer time 26 is designated by the user, a corrected check-out message may be sent to designated parties.

The server 12 and any computers and software adapted to monitor and message and otherwise track the event 22, continues to monitor the elapsed time from the user input start of the event 22 with the previously user-input time estimate for the individual event. Monitoring of the time period and event 22 related to the client or user 14 continues until a ‘check-in’ notification 29 is communicated to the computers or the server 12 of the service provider 13 monitoring the event 22. This is done upon the arrival/return time of the client or user 14 or within the buffer time period 26 input subsequent to the start of tracking of the event 22.

A check in notification 29 ceasing the monitoring of the time period and event 22 may be entered in the same fashion as the check out 27 noted above. This can be communicated in an electronic communication 30 such as the user calling on a cell phone or texting a message which communicates the check in notification 29 to the server 12. During the notification 29, the client or user 14 inputs a code, or the phone number of the user 14 is captured using caller ID, and the event 22 tracking ceases. However, due to the possibility of the client or user 14 being held against their will, or some other emergency situation, the system 10 may also have the option for a client or user 14 to send the communication 30 of what appears to be a check-in notification 29, but is in fact a pre-chosen trouble code for input during a check-in notification 29. This trouble code would elicit a normal response from the provider 13 to the user 14, but would input to the software running on the computers or server 12 for the service provider 13, that the subscribing client or user 14 is in trouble.

Assuming no trouble code is entered, and once the client or user 14 has input their stored check-in code notification 29, and that code is compared with and ascertained as associated with the tracked event 22, the time tracking service for the event 22 is ended. At this point, optionally, immediately or at a time duration after an arrival notification 31 of successful arrival, may be sent to emergency or designated contacts, for example, “Jane has successfully arrived at the Holiday Inn in Aspen”, or the system may simply cease monitoring the event 22. Or, as noted earlier, notifications may be sent to some contacts, and not to others based on the subscribing users input parameters for notification in the input profile 19. Consequently relatives who wish to know that the subscribing client or user 14 has successfully completed an event 22, for peace of mind sake, may be notified of such, but emergency contacts such as physicians, police, or paramedics, would not be notified of the completed event 22.

On the other hand, should the subscribing client or user 14 fail to provide the check-in notification 29, by the end of the time period being tracked and associated with the event 22, and within any leeway period if assigned to the event 22, the tracking service provider 13 will initiate a notification mode. In the notification mode, the software running through the server 12 or other computers of the service provider 13, will ascertain that the subscribing client or user 14 has exceeded the ultimate time of arrival/return inputted for the event 22, including leeway time 26 if any.

Upon the failure to provide a check-in notification 29, by the appropriate time, the service provider 13, employing software adapted to the task, may proceed to send out notifications 31 initially to the subscribing client or user 14 informing them of a failure to end the tracking period of the event 22. The subscribing client or user 14 will have a defined amount of time to respond to this alert notification 31, and if the reason for failure to check in was simply forgetting, then the subscribing user 14 is given the opportunity for a short time period, to end the tracking of the event 22 without other notifications 31 being issued.

If the subscribing client or user 14 sends the check in notification 29, and not the pre-chosen emergency signal if defined, the ‘successfully arrived’ mode of the notification 31, if required by the subscribing user input for such, will be sent to designated contacts for the individual event 22 by the service provider 13. This successful arrival message is of course optional and on some occasions may not be sent lest the system overload the designated contacts with information. However in the case of elderly or child subscribing clients or users 14, their caretakers may wish to continually be notified of such successful arrivals and cessation of a monitored event 22.

However, if the subscribing user fails to input the check-in notification 29 to the server or other input means for such to the service provider 13, or inputs the predetermined emergency code, then the notification 29 in the form of emergency messages will be sent to the emergency contacts the user has designated for the specific event 22 being tracked, for example, “Jane has failed to arrive to her destination on time, further action may be necessary”. At this point the designated contacts may be provided with information to contact the service provider 13 and/or emergency services.

In the event that the service provider 13 is opted to continuously track the user's terrestrial geographic progress along the designated route for the event 22, using GPS or cellular triangulation 23, or other means for such, the current or last known geographic position of the client or user 14 may also be communicated in the notification 31 sent to the contacts designated by the user which are relative to the individual event 22. This tracking of terrestrial geographic location may also be employed in an ongoing fashion to ascertain if the client or user 14 is on track to timely complete the trip in the designated time frame of the event 22 which the user has input.

Finally, employing GPS 23 that is conventionally built into many wireless phones and PDA's and the like and in two-way communicating GPS receivers, optionally, the service provider 13 or networked server 12, using software adapted to the task, may during any event 22 scheduled, employ the noted ongoing monitoring of the subscriber's terrestrial position. Employing this real time terrestrial location information, and comparing it to the input event 22 and input destination arrival time estimate, if the software ascertains a timely arrival at an input event 22 destination is not predicted, the software running on the server 12 or a communicating computer, may contact the subscribing client or user 14, to elicit an input for a buffer time 26. This active monitoring and user inquiry, allows the system to reset the arrival time for the event 22 of the subscribing client or user 14 for a new estimated time based on terrestrial position, and avoids needless notifications 31.

This ongoing position monitoring action may be particularly preferred to keep notifications 31 down, and could be easily enabled with a short text message to the subscribing user with a new time estimate of arrival and extend time to predicted arrival. The user would simply provide a yes or no, answer. The software running on the server would be adapted in this case to predict an arrival time based on real time terrestrial monitoring of the subscribing user, and offering the subscribing user one or a plurality of new times to input for the event end.

While all of the fundamental characteristics and features of the system for user event time tracking and notification invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An event tracking and emergency notification system for providing services to users, comprising:
allowing a user remote access to a server operated by a service provide;
allowing a user to input a user profile for electronic storage by said service provider;
said user profile including third party contact information for one or a plurality of third parties to be contacted on behalf of said user;
allowing said user, subsequent to said input of said user profile and contact information for said third parties, to access the server and input information concerning future events;
said information concerning future events including at least an estimated start time and an end time, a destination for said event, and a return point from said destination for said user at approximately said end time;
at substantially said start time, initiating a tracking of said user relative to said event;
ceasing said tracking only subsequent to a cessation input to said server, from said user, substantially at or prior to said end time; and
providing a notification to said third parties, subsequent to said end time, should said user fail to communicate said cessation input, said notification including information regarding destination and said return point and said user to said third parties, whereby said third parties can employ said information in said notification to attempt to locate said user.

2. The event tracking and emergency notification system of claim 1 additionally including:
allowing said user to input route information including travel route between said destination and said return point;
allowing said user to input a mode of travel along said travel route; and
employing said route information in said notification to third parties.

3. The event tracking and emergency notification system of claim 1 additionally including:
contacting said user, prior to providing said notification to said third parties, and allowing said user to amend said end time; and
resetting said end time to said secondary end time of said event; and
providing said notification to said third parties only if said user fails to communicate said cessation input after an elapse of said secondary end time.

4. The event tracking and emergency notification system of claim 2 additionally including:
contacting said user, prior to providing said notification to said third parties, and allowing said user to amend said end time, to a secondary end time; and
resetting said end time to said secondary end time of said event; and
providing said notification to said third parties only if said user fails to communicate said cessation input after an elapse of said secondary end time.

5. The event tracking and emergency notification system of claim 1 additionally including:
employing means for terrestrial location tracking of said user substantially in real time, to estimate a terrestrial position of said user, during the duration of said event; and
providing a last known said terrestrial location in any said notification to said third parties.

6. The event tracking and emergency notification system of claim 2 additionally including:
employing means for terrestrial location tracking of said user substantially in real time, to estimate a terrestrial position of said user, during the duration of said event; and
providing a last known said terrestrial location in any said notification to said third parties.

7. The event tracking and emergency notification system of claim 3 additionally including:
employing means for terrestrial location tracking of said user substantially in real time, to estimate a terrestrial position of said user, during the duration of said event;
employing said estimate of said terrestrial position of said user, to calculate said secondary end time;
communicating said secondary end time to said user; and
allowing said user to designate said secondary end time as said end time for said event.

8. The event tracking and emergency notification system of claim 4 additionally including:
employing means for terrestrial location tracking of said user substantially in real time, to estimate a terrestrial position of said user, during the duration of said event;
employing said estimate of said terrestrial position of said user, to calculate said secondary end time;
communicating said secondary end time to said user; and
allowing said user to designate said secondary end time as said end time for said event.

9. The event tracking and emergency notification system of claim 7 additionally including:
providing a last known said terrestrial location in any said notification to said third parties.

10. The event tracking and emergency notification system of claim 8 additionally including:
providing a last known said terrestrial location in any said notification to said third parties.
